(19) United States
(12) Patent Application Publication
(10) Pub. No.: US 2008/0294473 A1
(43) Pub. Date: Nov. 27, 2008

(54) System and Method for Automatic Testing of Planning Results

(75) Inventors: Alexander Fay, Hamburg (DE); Rainer Drath, Weinheim (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/096,115

(22) PCT Filed: Nov. 25, 2006
(86) PCT No.: PCT/EP06/11319

§ 371 Date: Jul. 22, 2008

(30) Foreign Application Priority Data
Dec. 9, 2005 (DE) 10 2005 058 802.6

(51) Int. Cl. G06Q 10/00

(52) U.S. Cl. 705/7

(57) ABSTRACT

A system and a method are disclosed for automatically testing planning results, the tests being made possible by a data processing device in which planning results that are to be verified are stored in an electronic format, and with the aid of software used for performing automatic and systematic tests. The software can contain test criteria that are stored in the form of rules as well as test programs which have access to the planning results and the rules. Additionally, display and/or output media are provided to output test results.

This application claims priority as a continuation application under 35 U.S.C. §120 to PCT/EP2006/011319 filed as an International Application on Nov. 25, 2006, and under 5 U.S.C. §119 to German Patent Application No. 10 2005 058 802.6 filed in Germany on Dec. 9, 2005, the entire contents of which are hereby incorporated by reference in their entireties.

### BACKGROUND

The invention relates to a system and a method for automatic testing of planning results in the field of installation technology and/or process control technology. A system and a method such as this can be used for automatic validation and verification of various information items which are created during the planning of technical installations and are in electronic form, in particular topology information items.

Installations are planned in steps with the process being characterized in particular by phases of data interchange with adjacent planning phases. In this case, the data is frequently transferred manually, that is to say printed or handwritten originals are transferred manually to software tools. Furthermore, automatic data transfer mechanisms also exist, and are frequently based on Excel, databases or ASCII files such as CSV or XML. However, electronic data transmission such as this is carried out essentially mechanistically, without, or only with very simple, automatic checking of the content of the information.

The invention is based on the known use of electronic installation information which can be interpreted semantically and automatically. Approaches such as these have been known for some time and are already in practical use and are described, inter alia, in:
Till Schmidberger and Alexander Fay, Rainer Drath, “Automatisiertes Engineering von Prozessleitsystem-Funktionen” [Automated Engineering of Process Control System Functions], in atp—Automatisierungstechnische Praxis, 2/2005, pp. 45-51. ISSN 0178-2320,
Rainer Drath, Murat Fedai, “CAEX613 ein neutrales Datenaustauschformat fur Anlagendaten—Teil 1” [CAEX—a neutral data interchange format for installation data—Part 1], in atp —Automatisierungstechnische Praxis, 2/2004, pp. 52-56,
Rainer Drath, Murat Fedai, “CAEX—ein neutrales Datenaustauschformat fur Anlagendaten—Teil 2” [CAEX—a neutral data interchange format for installation data—Part 2], in atp —Automatisierungstechnische Praxis, 3/2004, pp. 20-27,
DE 103 08 725 A1: “System und Verfahren zum Verwalten und zum Austausch von Daten eines technischen Projektes, einer technischen Anlage sowie einzelner Anlagenkomponenten” [System and method for management and for interchange of data for a technical project, a technical installation and individual installation components], and
Schmidberger T., Fay A., Drath R.: “Automatische Erstellung von Verriegelungssteuerungen” [Automatic creation of locking control systems]. in: atp 2/2005, Oldenbourg Verlag, 2005, pages 45-51.

Planning information can be mapped hierarchically and on an object-oriented basis, for example using tree structures. The following planning information typically occurs in this case:
installation topology information, that is to say the process-technical structure,
control technology topology information relating to the control-technology hardware structure, including wiring,
control technology functional topologies, that is to say the control technology software structure,
project topology, in particular projects, sub-projects, sub-tasks,
planning topology, that is to say the stored predicted structure of the plan,
project structure information which relates to the modular, hierarchical and/or content composition of the product or of the products which is or are manufactured on the installation, and
production process topology, that is to say production process information, that is to say the procedure structure of the production process, for example in the form of “recipes” or action sequences.

Such manually created, manually imported or partially-automatically imported information is checked manually, or at best partially automatically, for its correctness. Because of the random errors that occur, human testing does not in this case allow any reliable statement to be made about the correctness of the information. Partially automatic testing covers only low-level and simple relationships, and is not suitable for testing generic relationships.

The correctness of information should, however, relate to
a complete and worthwhile installation topology,
a complete and worthwhile control technology topology,
a complete and worthwhile control technology functional topology,
a complete and worthwhile project topology,
a complete and worthwhile planning topology,
complete and worthwhile project structure information,
complete and worthwhile product process information, and
complete and worthwhile relationships between the topologies, components and structures.

The topology information is normally tested at the following three points in the planning process:
1. when information is transferred from adjacent planning phases, with the test determining whether the information has arrived correctly,
2. on the basis of planning information at the particular processing phase, and
3. on the basis of the implementation, for example by means of tests during commission. Data transmission errors and planning errors generally lead to an error or fault during commission. It is therefore particularly important to test the planning information, which takes a considerable amount of time and, if errors are not identified, can lead to serious consequences during operation of the installation.

### SUMMARY

Against this background, the invention is based on the object of automating the testing of planning results in the field of installation technology and/or process control technology, in particular of topology information, in order to avoid errors and faults and to allow commissioning to be carried out more quickly, at a higher quality level, and more efficiently.

This object is achieved by a system for automatic testing for planning results in the field of installation technology and/or process control technology, having the features specified in claim 1. A corresponding method and advantageous refinements are specified in further claims.

The invention therefore proposes a system and a method for automatic testing of planning results in which tests are carried out by means of a data processing device, in which planning results to be tested are stored in electronic form, and by software means for carrying out automatic and systematic tests. The means contain test criteria stored in the form of rules, as well as test programs which have access to the planning results and to the rules. In addition, display and/or output means are provided for outputting test results.

Planning topologies are therefore required in electronic form in order to carry out the invention, and this is achieved, for example, by the use of an object-oriented topology data model or by the export of such information to a data format such as this. By way of example, this data is in the CAEX format, as described above in the references. A further precondition for carrying out the invention is semantic interpretability of the information, that is to say the objects must be able to signal to the processing device what their type is and what role they play in their environment.

The method according to the invention works with test criteria in the form of rules which are used in order to automatically and systematically analyze topology information in electronic form. Such rules are generic descriptions of required causal links and relationships. If the condition part of the rule can be applied to one or more elements of one or more of the topologies or further rules, then the consequence part of the rule indicates what other situation or relationship, relating to identical or different elements of the same or different topology or topologies or rules, must be provided. In contrast to manual testing, automatic checking is deterministic and is not subject to any random errors, as a result of which the test process is traceable, recordable and therefore verifiable. The capability to verify the correctness of information relating to defined criteria is one of the major advantages of this procedure.

The method according to the invention can be used in various phases of a planning process and during the course of commissioning, for example during a transition from installation planning to control technology planning, during the transition to subsequent commissioning, and during commissioning.

Examples of such applications are

### A Test of the Completeness of Installation Topologies:

In this case, the aim is to test whether the installation components to be imported and/or planned are linked to one another in a worthwhile manner, for example with every tank with inlets also having at least one outlet, with every tank with outlets having at least one inlet, without the possibility of pumps operating against one another, or pipes not having any free ends.

### Test of Completeness of Control Technology Topology:

In this case, the aim is to test whether the control technology components to be imported and/or planned are linked to one another in a worthwhile manner, for example with every sensor/actuator being connected to a bus system or to some other information transmission system, with components of the control technology topology being supplied with electricity, with operative lines being related to one another in a worthwhile manner, with no missing operative lines, or with information couplings linking compatible data types.

### Test of Completeness of Control Technology Functional Topology:

In this case, the aim is to test whether the control technology functional modules to be imported and/or planned are linked to one another in a worthwhile manner, with signals being correctly linked to one another, or with the associated processor having the capability to process the number of the control technology functions.

### Test of Consistency Between the Topologies:

In this case, the aim is to test whether the components of the various technologies are related to one another in a worthwhile form, for example with every pump or every conveyor belt in the installation topology having a drive in the control technology topology, with each production flow in the production process information being supported or forced by a conveyor element in the installation topology, thus making it possible to check whether a specific production procedure can be carried out in an installation, or with every possible product flow having a valid start and a valid end.

### BRIEF DESCRIPTION OF THE DRAWING FIGURES

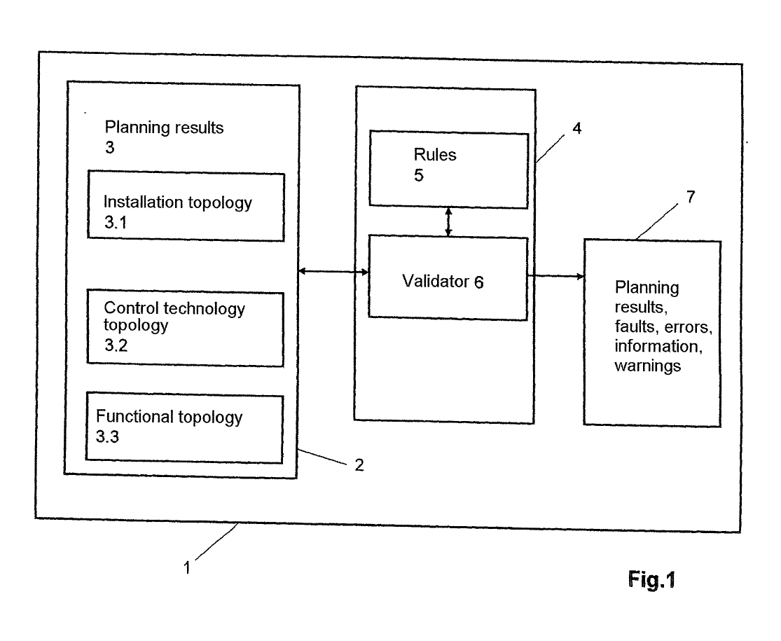

The invention as well as advantageous refinements or improvements and further advantages of the invention will be explained and described in more detail with reference to the exemplary embodiment illustrated in FIG. 1, below.

### DETAILED DESCRIPTION

FIG. 1 shows a system for automatic testing of planning results, with a data processing device 1 being provided which has memory devices 2, means 4 for carrying out tests, as well as display and/or output means 7 for outputting test results. Planning results 3, for example an installation topology 3.1, a control technology topology 3.2 and a functional topology 3.3, are stored in the memory devices 2. The test means 4 contain a validator 6, which has access to the planning results 3, 3.1, 3.2, 3.3 and to rules 5. The validator 6 is a processing device in which test programs run. The test programs are designed to carry out tests which are described above, by way of example, as applications, or completeness tests. The rules 5 which are used as test criteria for carrying out the tests have likewise already been described above. Planning results which can be output by means of the display and/or output means 7 are, for example, errors, faults, information, warnings or alternative proposals.

The operation of a test program will be explained in more detail in the following text with reference to one typical test procedure. A test program applies one of the stored rules to the available data. To do this, the test program first of all confirms whether the topological relationship described in the rule premise exists between the object to be tested and other objects and attributes in the installation data. One simple example would be: “IF the object which is at a higher level than the object to be tested has the attributed x . . . ”. In this case, the relationship described in the premise may also cover a plurality of objects and a plurality of attributes, and various topologies. If the test program finds a relationship such as this at one or more points in the installation data, then it checks at each of these points whether the situation described in the rule conclusion is also satisfied. By way of example, the latter may be a simple condition for one attribute, or else more complex conditions which relate to the existence and form of objects, attributes and/or topological and other relationships between objects and/or attributes. Once the test program has applied these rules to all the available application options, it carries out this process successively for the other stored rules.

A test method which can be carried out using a test system such as this can likewise be explained with reference to FIG. 1: once planning results in a suitable electronic form, rules and test programs have been stored in the system, selected tests can be carried out in an automated form. The respective test program accesses the planning results, carries out tests in accordance with associated rules, and outputs test results for display, recording or for other processing.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A system for automatic testing of planning results in the field of installation technology and/or process control technology, wherein
a) a data processing device is provided and contains memory devices in which planning results to be tested are stored in electronic form,
b) the data processing device has means for carrying out automatic and systematic tests, with the means containing test criteria, which are stored in the form of rules, for carrying out the tests, and has a validator with at least one test program which has access to the planning results and to the rules and
c) display and/or output means are provided for outputting test results.

2. The system as claimed in claim 1, wherein the planning results to be tested each contain at least one installation topology and/or control technology topology and/or functional topology and/or planning topology and/or project topology and/or process topology.

3. The system as claimed in claim 1, wherein the data processing device outputs faults, errors, information, warnings or alternative proposals as test results.

4. The system as claimed in claim 1, wherein the data in the planning results is in a hierarchical, object-oriented data format.

5. A method for automatic testing of planning results in the field of installation technology and/or process control technology, wherein a data processing device is provided, in which
planning results to be tested are provided in electronic form, and
at least one test program and test criteria are stored in the form of rules and wherein, in an automated form,
a) the planning results are analyzed systemically by means of at least one test program—using the rules—and
b) test results, in particular faults, errors, information and warnings, are output.

6. The method as claimed in claim 5, wherein rules are used which are generic descriptions of required causal links.

7. The method as claimed in claim 5, wherein data of in each case at least one installation topology, and/or control technology topology and/or functional topology and/or planning topology and/or project topology and/or process topology is used as planning results to be tested.

8. The method as claimed in claim 5, wherein the data in the planning results is in a hierarchical, object-oriented data format.
